(19) United States
(12) Patent Application Publication
(10) Pub. No.: US 2007/0044669 A1
(43) Pub. Date: Mar. 1, 2007

(54) ALUMINUM CAN COMPACTING MECHANISM WITH IMPROVED ACTUATION HANDLE ASSEMBLY

(76) Inventor: Gregory D. Geise, Menomonee Falls, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/467,028

(22) Filed: Aug. 24, 2006

Related U.S. Application Data
(60) Provisional application No. 60/711,072, filed on Aug. 24, 2005.

(51) Int. Cl. B30B 1/02

(52) U.S. Cl. 100/902; 100/293

(57) ABSTRACT

An aluminum can compacting device comprising a pair of side support members having a a first compacting plate situated therebetween. Rotatably affixed to the side support members are two handle lever members which, when rotated from a generally upwardly extending position to a downward position, cause a second compacting plate to move downwardly towards the first compacting plate thereby compacting an aluminum can located between them. The compacting plates may utilize at least one alignment rod. If so, one of the compacting plates would have feature an alignment rods and the other plate would be functionally adapted to be movable along the alignment rods. An improved handle is provided which is attached between the handle members such that it is rotatable within the receiving apertures, thus allowing the user's hand to firmly grasp the handle throughout the compacting cycle. With the improved handle of the present invention, there is no need for the user to re-position his or her hand or alter his or her grasp of the handle during the compacting cycle or even between consecutive or repeated compacting cycles.

### PRIORITY

This application claims the benefit of U.S. Provisional Application No. 60/711,072, filed Aug. 24, 2005.

### FIELD OF THE INVENTION

This invention relates generally to mechanisms for compacting objects. More particularly, it relates to a hand-actuated mechanism for compacting aluminum cans, which mechanism is constructed in accordance with prior design but which includes an improved handle. The improved actuation handle assembly allows the user to rotate an actuating sub-assembly and cooperating levers of the mechanism without releasing his or her grip during the rotation cycle.

### BACKGROUND OF THE INVENTION

It is well known that the recycling has become a way of life in our energy-conscious society. One object that is often recycled is the aluminum can, an object that is found just about everywhere that beverages are sold or distributed. Unfortunately, discarded aluminum cans are equally ready to find. This inventor has previously recognized that a movement is taking place to manufacture, distribute and sell aluminum can crushing and compacting mechanisms that can be readily purchased and used by the consuming public. In fact, this inventor has done his share to promote the re-cycling of aluminum cans. The applicant has previously patented the basic compacting mechanism that is intended to be used with the improvement herein, U.S. Pat. No. 6,076,455 entitled “Aluminum Can Compacting Mechanism.” The applicant has also subsequently filed co-pending applications for related aspects of that compacting mechanism, U.S. patent application Ser. Nos. 10/959,728 and 29/230,879.

In the devices of prior manufacture, such can compacting mechanisms typically utilize a can retaining means into which the user manually places the aluminum can that is to be compacted. A lever, or similar mechanism, is actuated and the aluminum can is compacted between at least two crushing members or plates. The lever is then reversed and the compacted can is manually removed from the device. In the particular mechanism previously patented by this inventor, the last step of this process was effectively eliminated. That particular mechanism uses gravity to effect the removal of the compacted can from between the compacting plates.

What is needed, however, is an improved actuation handle assembly that allows the user to grip the handle only once at the start of the compaction process and that also allows the user to maintain that grip and that grip position throughout the compaction cycle without any need for the user to re-position his or her hand during the compaction cycle. In other words, what is needed is a handle that moves with the user's hand, as opposed to a handle that requires the user to re-position his or her hand during use. This greatly improves the performance of the mechanism and also make it easier for the user to operate. What is also needed is such an improved handle assembly that is relatively easy to manufacture, that can be quickly installed on levers of existing structure, and that uses a handle that is longitudinally symmetrical to allow for installation of the handle in either of its two positions.

### SUMMARY OF THE INVENTION

It is, therefore, a principal object of this invention to provide a new, useful and uncomplicated can compacting mechanism having an improved actuation handle assembly that utilizes a minimum number of elements, which is easy to assemble and which is easy to use. It is another object of this invention to provide such an improved actuation handle assembly that is relatively inexpensive to manufacture and that, as in the preferred embodiment disclosed herein, retains the characteristic that the entire mechanism continues to be a relatively inexpensive item for members of the purchasing and consuming public.

The present invention has obtained these objects. It provides, in the preferred embodiment, for an aluminum can compacting device of current design having a back support base and a pair of side support members extending from it. Situated between the support members are two compacting plates. The compacting plates utilize a pair of alignment rods, one plate having the alignment rods affixed therewithin and the other plate being functionally adapted to be movable along the alignment rods. Rotatably affixed to the movable plate are two handle lever members which, when rotated from a generally upwardly extending position to a downward position, cause the compacting plates to move towards each other thereby compacting an aluminum can located between them. The improved handle assembly of the present invention is insertable within receiving apertures defined within the distal end of each of the two handle lever members. An improved handle is provided which is rotatable within the receiving apertures, thus allowing the user's hand to firmly grasp the handle throughout the compacting cycle. With the improved handle of the present invention, there is no need for the user to re-position his or her hand or alter his or her grasp of the handle during the compacting cycle or even between consecutive or repeated compacting cycles. The foregoing and other features of the device of the present invention will be further apparent from the detailed description which follows.

### BRIEF DESCRIPTION OF THE DRAWINGS

FIG. 1 is a perspective view of an aluminum can compacting mechanism that uses one embodiment of the improved handle assembly that is constructed in accordance with the present invention.

FIG. 2 is right side elevational view of the mechanism shown in FIG. 1 and showing the mechanism in its full compaction or handle lowered position and also showing the mechanism in its fully upright position in phantom view.

FIG. 3 is an enlarged and partial right side elevational view of one end of the improved handle assembly taken along Line 3-3 of FIG. 2.

FIG. 4 is an enlarged and partial right side elevational view of the opposite end of the improved handle assembly taken along Line 4-4 of FIG. 2.

FIG. 5 is an enlarged and exploded perspective view of one end of the improved handle assembly of the present invention taken along Line 6-6 of FIG. 1.

FIG. 6 is an enlarged perspective view of the same end of the improved handle assembly illustrated in FIG. 5 but showing the handle end attached to the lever member.

FIG. 7 is an enlarged front elevational view of the improved handle assembly of the present invention.

FIG. 8 is a front elevational and cross-sectional view of the improved handle assembly taken along Line 7-7 of FIG. 1.

FIG. 9 is a further enlarged front elevational and cross-sectional view of one end of the handle assembly taken along Line 8-8 of FIG. 7.

FIG. 10 is an even further enlarged front elevational and cross-sectional view of one end of the handle assembly taken along Line 10-10 of FIG. 8.

### DETAILED DESCRIPTION

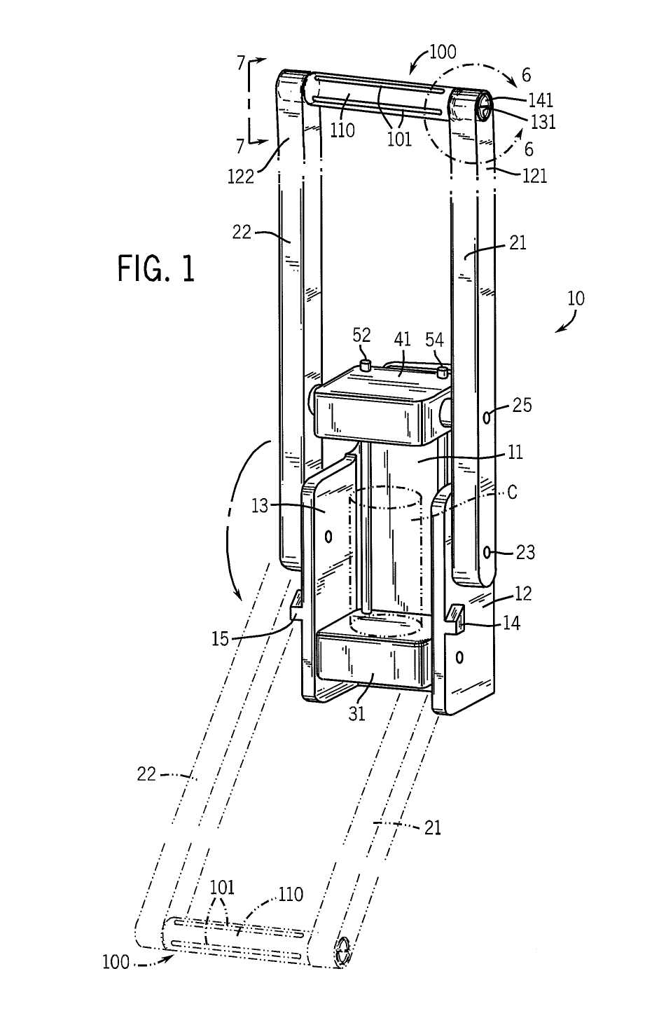

Referring now to the drawings in detail, FIG. 1 illustrates an aluminum can compacting mechanism that is constructed substantially in accordance with prior design, and specifically in accordance with this inventor's U.S. Pat. No. 6,076,455 (the '455 patent), but which also includes the improved handle assembly, generally identified 100, of the present invention. The description and functionality of the prior mechanism as described in the '455 patent, at Col. 2, Line 44 to Col. 4, Line 55, is incorporated herein by reference.

In general, the mechanism includes a base having a back support portion 11 which is a generally flat planar member that is functionally adapted to be anchored to a surface, such as a wall. Extending outwardly and generally perpendicularly from the back support portion 11 of the base are two side support members 12, 13. The right side support member 12 and the left side support member 13 are generally parallel to one another. Each of the side support members 12, 13 is provided with a side stop member 14, 15, respectively. The stop members 14, 15 are situated to the outside surfaces of the side support members 12, 13, respectively. The function of the side stop members 14, 15 is to limit the downward movement of the “pull” mechanism portion of the mechanism. The pull mechanism includes a right pull member 21 and a left pull member 22. Each pull member 21, 22 includes a distal end 121, 122, respectively. The proximal end of the right pull member 21 includes a pivot hole 23. Similarly, the left pull member 22 includes, at its proximal portion, a pivot hole 26. Located away from the pivot hole 23 of the right pull member 21 is a top pressure plate hole 25. Its counterpart (not presently shown) is a top pressure plate hole in the left pull member 22.

The base mechanism further includes a bottom pressure block 31 that includes a generally flat top surface. The sides of the bottom pressure block 31 are functionally adapted to fit within the base side support members 12, 13. A second block, a top pressure block 41, is included and is generally configured to be of the same physical dimensions as the bottom pressure block 31. Each of the top and bottom pressure blocks 41, 31 are configured with rearwardly located holes through which two alignment rods 52, 54 are intended to pass. The alignment rods 52, 54 are fastened at one end within the bottom pressure block 31 and are functionally adapted to remain rigid therewithin. The alignment rods 52, 54 are functionally adapted to freely pass through holes (not shown) within the top pressure block 41.

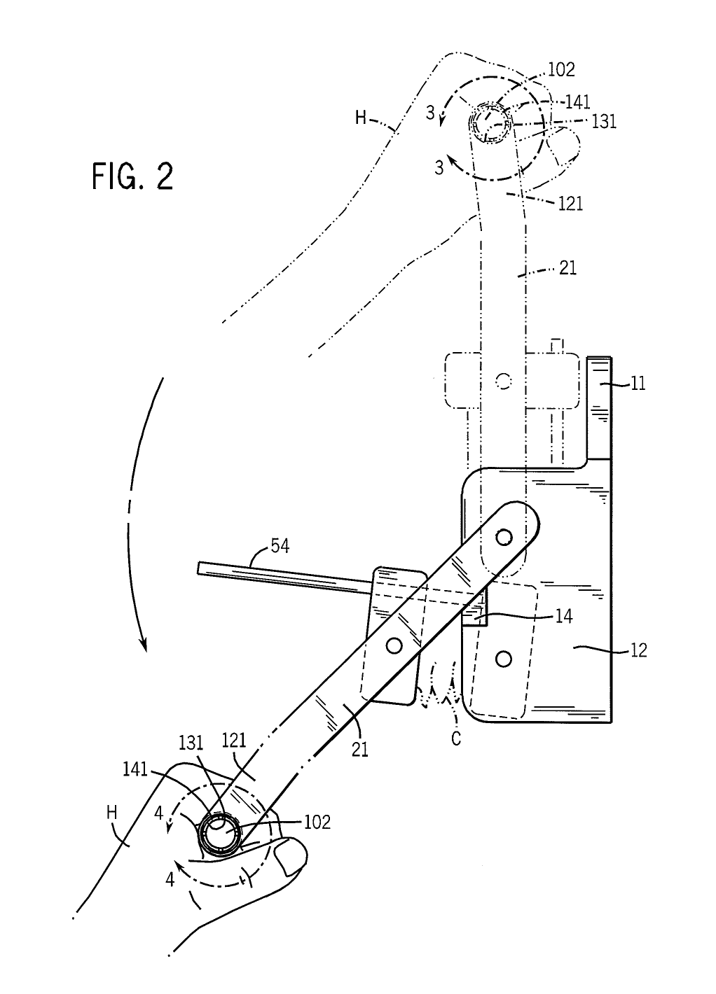

As mentioned earlier, FIG. 1 shows a preferred embodiment of the improved actuation handle assembly, generally identified 100, that is constructed in accordance with the present invention. As shown in FIG. 7, the improved handle assembly 100 includes a cylindrical handle structure 110 having a hollow interior 102, a first longitudinal end 111 and a second longitudinal end 112. The handle structure 110 is symmetrical about its axis and each of its ends 111, 112 are identically configured. Accordingly, any discussion concerning the first end 111 relative to the distal end 121 of the lever 21 is equally applicable to the second end 112 relative to the distal end 122 of the lever 22. Indeed, the handle structure 110 could be “flipped around” and the ends 111, 112 of each would functionally cooperate with either lever 21, 22. This is an aid to assembly of the device. Referring again to FIG. 7, it will be notices that a number of longitudinally-extending ridges 101 are defined within outer surface of the handle structure 110. Their presence aids the user in his or her ability to grasp the handle structure 110 during the compaction cycle with his or her hand H. See FIG. 2, which will be discussed in greater detail later in this detailed description.

Referring now to FIG. 5, it will be seen that the end 111 of the handle structure 110 includes a certain configuration. Moving outwardly from the transverse center of the handle structure 110, a first shoulder 113 is circumferentially defined within the end 111, as are a smaller diameter cylindrical section 114 and a second shoulder 115. The first and second shoulders 113, 115 are provided as means for limiting longitudinal movement of the handle structure 110 along its axis when the handle structure 110 is assembled as intended. Extending further outwardly from the end 111 is a plurality of arcuately-shaped extension members 141. In the preferred embodiment, four such extension members 141 are provided. However, such is not a limitation of the present invention. Each extension member 141 extends from a common base portion 140 at its proximal end. At the distal end 144 of each extension member 141 is a stop member 143. In the preferred embodiment, the handle structure 110 is made of a resilient plastic material, such material having a “memory” such that, when the extension members 141 are flexed slightly inwardly, each member 141 tends to return to its original position. See, for example, FIGS. 9 and 10. This “flexing” capability is provided by means of longitudinally-extending slots 145 that are defined between each of the extension members 141. See, again, FIG. 5 in particular.

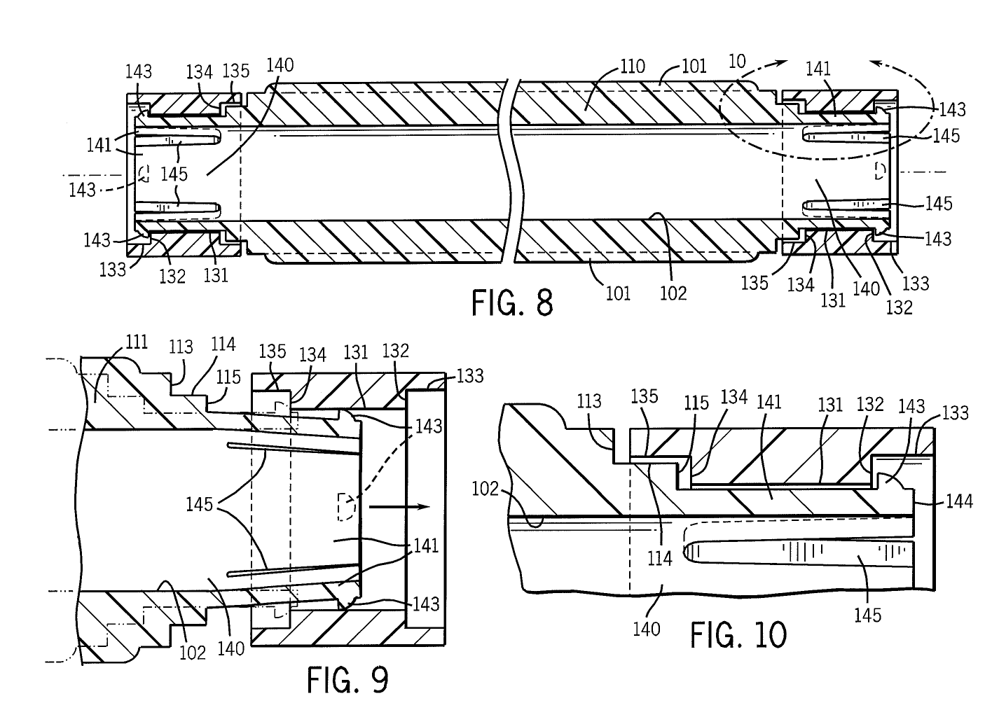

The assembly 100 of the present invention also includes modifications to the distal ends 121, 122 of each of the levers 21, 22 previously employed. Specifically, each lever end 121, 122 includes an aperture 131 defined within it. The diameter of this aperture 131 corresponds roughly with the diameter of the end 111 of the handle structure 110 at the point of the extension members 141. Outwardly of the aperture 131, and to either side of it, is an aperture shoulder 132 and a second outer aperture 133, the outer apertures 133 having a diameter that corresponds roughly with the diameter of the end 111 of the handle structure 110 at the point of the cylindrical section 114. See FIGS. 8 and 10.

When the end 111 of the handle structure 110 is fully inserted into the lever aperture 131, the handle structure 110 is essentially “snap-fitted” into the lever aperture 131. This “snap-fit” is intended for assembly purposes to be more or less permanent. The handle structure shoulders 113, 115 serve as “stops” for the longitudinal movement of the handle structure 110. See FIG. 10. In that position, the catch 143 effectively engages the aperture shoulder 132 to the other side of the lever aperture 131. Prior to this engagement, the extension members 141 “flex” inwardly of the handle structure 110, as is shown in FIG. 9.

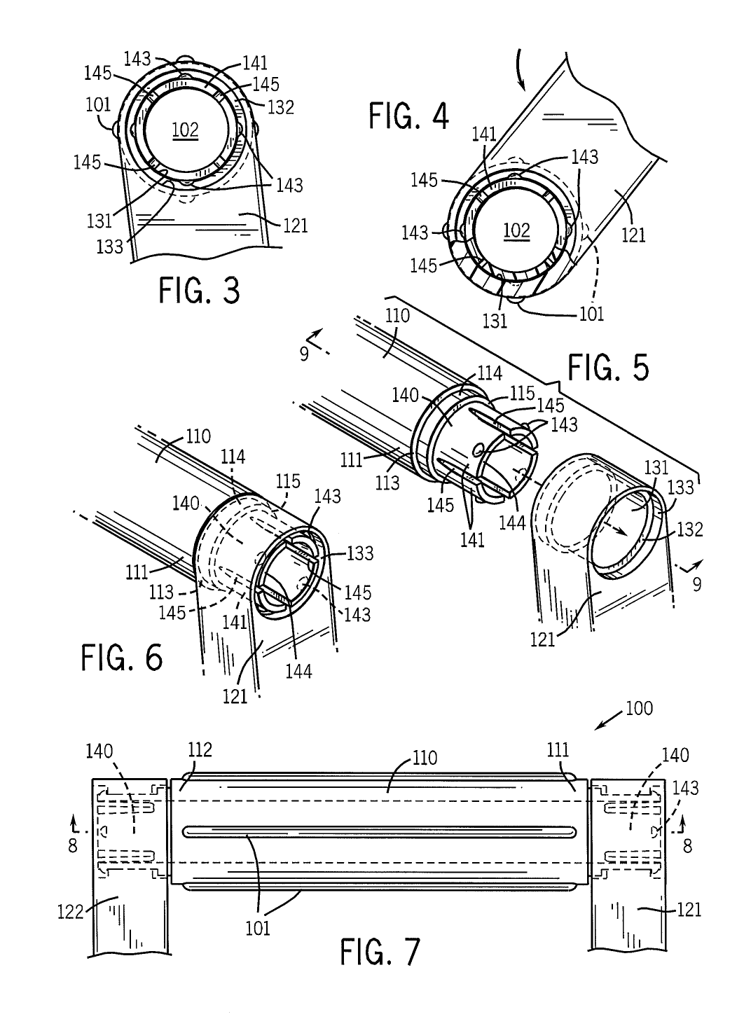

Once engaged, as is shown in FIGS. 3, 4, 6, 7 and 10, the handle structure 110 is freely rotatable at each end 111, 112 as each end 111, 112 is retained within the lever apertures 131. While freely rotatable, the handle structure 110 and the lever apertures 131 are configured to provide structural integrity and a certain amount of lateral rigidity to the assembly 100. In this rotatable position, the user can grip the handle structure 110 with his or her hand H when the levers 21, 22 are in their fully upright position as is shown in phantom view in FIG. 2. As the user's hand H pulls the levers 21, 22 downwardly to effect compaction of the can C within the mechanism 10, the handle structure 110 rotates within the lever apertures 131 and the user's hand H can retain its original grip on the handle structure 110.

The handle structure 110 is then moved upwardly to begin the opening cycle of the mechanism 10. This motion causes the top pressure block 41 to begin its upward motion along the alignment rods 52, 54 and away from the bottom pressure block 31. As the handle structure 110 moves towards its uppermost position, the aluminum can, now compacted, drops out from within the crushing mechanism 10 without the need for handling the compacted can C. The handle structure 110 is then raised to its fully upright position and a new aluminum can C can be inserted for a new compacting cycle to begin, all without the need for the user to re-position his or her hand H.

From the foregoing detailed description, it will be apparent that there has been provided a new, useful and uncomplicated can compacting mechanism that has an improved actuation handle assembly that utilizes a minimum number of elements, which is easy to assemble and which is easy to use; that is relatively inexpensive to manufacture and that, as in the preferred embodiment disclosed herein, retains the characteristic that the entire mechanism continues to be a relatively inexpensive item for members of the purchasing and consuming public.

What is claimed is:

1. An aluminum can compacting mechanism comprising:
a pair of side support members, each of said side support members extending generally upwardly, each of said support members having an upper portion and a lower portion;
a first compacting block, said first compacting block extending between the lower portions of said side support members and being permitted to rotate about a fulcrum relative to the side support members;
a pair of pull members, the pull members each having a distal end and a proximal end, the proximal end being connected to and extending upwardly from the upper portions of the side support members, each pull member being permitted to rotate about a fulcrum between a generally upwardly extending position and a substantially downwardly extending position;
a handle extending between the distal ends of the pull members, the handle being permitted to rotate relative to the pull members;
a second compacting block, the second compacting block extending between the handle members, the second compacting block being permitted to rotate relative to the handle members;
means for keeping the first compacting block and the second compacting block in substantially parallel planar relation;
wherein if the cylindrical handle member is drawn downwardly, the second compacting block is drawn downwardly towards the first compacting block.

2. The aluminum can compacting mechanism of claim 1 wherein the means for keeping the first compacting block and the second compacting block in substantially parallel planar relation comprises at least one block alignment rod extending generally perpendicularly from the first compacting block.

3. The aluminum can compacting mechanism of claim 2 wherein the means for keeping the first compacting block and the second compacting block in substantially parallel planar relation further comprises at least one hole defined within the second compacting block.

4. The aluminum can compacting mechanism of claim 1 wherein the handle is generally cylindrical.

5. The aluminum can compacting mechanism of claim 1 wherein the handle provides a plurality of longitudinally extending ridges.

6. An aluminum can compacting mechanism comprising:
a pair of side support members, each of said side support members extending generally upwardly, each of said support members having an upper portion and a lower portion;
a first compacting block, the first compacting block extending between the lower portions of the side support members and being permitted to rotate relative to the side support members;
a pair of pull members, each of the pull members each having a distal end and a proximal end, the proximal end being connected to and extending upwardly from the upper portions of the side support members, each pull member being permitted to rotate between a generally upwardly extending position and a substantially downwardly extending position;
a handle extending between the distal ends of the pull members, the handle being permitted to rotate relative to the pull members;
a second compacting block having at least one hole defined therewithin, said second compacting block extending between the handle members, the second compacting block being permitted to rotate relative to the handle members;
at least one block alignment rod extending generally perpendicularly from the first compacting block to the hole in the second compacting block to keep the first compacting block and the second compacting block in substantially parallel planar relation;
wherein if the cylindrical handle member is drawn downwardly, the second compacting block is drawn downwardly towards the first compacting block.

7. The aluminum can compacting mechanism of claim 6 wherein the handle is generally cylindrical.

8. The aluminum can compacting mechanism of claim 6 wherein the handle provides a plurality of longitudinally extending ridges.
